(19) United States
(12) Patent Application Publication
(10) Pub. No.: US 2008/0260949 A1
(43) Pub. Date: Oct. 23, 2008

(54) Solvent Recovery System and Process

(76) Inventor: Howard Snoad, Auckland (NZ)

Correspondence Address: GREER, BURNS & CRAIN, 300 S WACKER DR, 25TH FLOOR, CHICAGO, IL, 60606, US

(21) Appl. No.: 11/665,233

(22) PCT Filed: Oct. 12, 2005
(86) PCT No.: PCT/NZ05/00266

§ 371 Date: Feb. 14, 2008

(30) Foreign Application Priority Data
Dec. 10, 2004 (NZ) 535897

(51) Int. Cl. B27K 5/00

(52) U.S. Cl. 427/297; 427/351; 427/591

(57) ABSTRACT

This invention relates to a solvent recovery system and process from timber. Preferably, although not exclusively, the present invention relates to exposing the timber to a reduced pressure and a source of radio frequency energy. Advantageously the preferred embodiments of the present invention may have a number of advantages over the prior art which may include: “lower cost of production; “increased speed of operation; “lower environmental impact; and “more environmentally friendly product.

### TECHNICAL FIELD

The present invention relates to a solvent recovery system and process. Preferably, although not exclusively, the present invention relates to a process and system for the removal of solvent from timber.

### BACKGROUND ART

Timber is often chemically treated to improve properties like its stability to environmental exposure. The chemicals used to treat the timer may be varied depending on the effect desired and the intended use of the timber. One common treatment includes light organic solvent preservative (LOSP) impregnation of the wood.

The treatment of timber with LOSP typically involves the use of a controlled vacuum to cause the solvent to penetrate into the timber cells. It is known to subsequently try and recover any excess solvent from the timber using a vacuum. However, the treatment process takes around half an hour and, in warm weather, processed timber can be painted in around a week. In cold weather, however, evaporative loss of solvent from the timber under vacuum may take weeks.

One advantage of LOSP is that it does not swell or distort the profiled wood. This allows the timber to be treated in its final shape. The process causes little discolouration of the treated product and eliminates waste associated with water-based preservative techniques. Water soluble chemicals used in such techniques are discarded in the sawdust and shavings and present an environmental hazard.

Currently all solvents used in LOSP treatment in New Zealand are lost directly into the atmosphere. New Zealand is a signatory to the Kyoto Convention on volatile organic compound emissions and this solvent loss is therefore undesirable. Furthermore, trade in wood products made using ‘non-environmentally friendly’ methods is likely to be restricted at some stage due to an anticipated tightening of emission rules in other jurisdictions.

Some overseas jurisdictions require that products sold there must have any solvent used during manufacture removed. LOSP is not used in some jurisdictions, for example the United States, because of the environmental impact of emissions.

It is an object of the present invention to provide a novel process and apparatus for the removal of solvent from timber or at least provide the public or industry with a useful alternative.

All references, including any patents or patent applications cited in this specification are hereby incorporated by reference. No admission is made that any reference constitutes prior art. The discussion of the references states what their authors assert, and the applicants reserve the right to challenge the accuracy and pertinence of the cited documents. It will be clearly understood that, although a number of prior art publications are referred to herein, this reference does not constitute an admission that any of these documents form part of the common general knowledge in the art, in New Zealand or in any other country.

It is acknowledged that the term ‘comprise’ may, under varying jurisdictions, be attributed with either an exclusive or an inclusive meaning. For the purpose of this specification, and unless otherwise noted, the term ‘comprise’ shall have an inclusive meaning—i.e. that it will be taken to mean an inclusion of not only the listed components it directly references, but also other non-specified components or elements. This rationale will also be used when the term ‘comprised’ or ‘comprising’ is used in relation to one or more steps in a method or process.

Further aspects and advantages of the present invention will become apparent from the ensuing description which is given by way of example only.

### DISCLOSURE OF INVENTION

The present invention relates to a process for the removal of solvent from timber comprising the step of exposing treated timber to a reduced pressure and a source of radio frequency energy.

The treated timber may be wood treated with any number of agents selected from the group insecticides, fungicides, bactericides, flame retardants, and any preservative or other treatment chemical such as dinitrophenol, pentachlorophenol, chloronaphthalenes, chlorobenzenes, lindane, dieldrin, organophosphorous and carbamate compounds, and copper/zinc naphthenates.

In preferred embodiments the treated timber may be wood treated with a preservative.

The solvent may be any substance or combination of substances that is normally a liquid at room temperature and pressure or any substance capable of dissolving any timber treatment agent.

In preferred embodiments the solvent may be an organic solvent.

In particularly preferred embodiments the solvent may be light organic solvent or that petroleum fraction between gasoline and kerosene.

The timber for use in the process and apparatus of the invention is preferably sawn timber that has been treated with an approximately 10% w/v solution of a timber preservative in light organic solvent.

In preferred embodiments the radio frequency energy may be applied intermittently.

In preferred embodiments the radio frequency energy may be applied when the vapour mix at the surface of the timber is either above the upper explosive level or below the lower explosive level of the solvent.

In preferred embodiments the pressure may be reduced rapidly such that the pressure differential between the interior of the timber and the surface assists in the migration of solvent to said timber surface.

In preferred embodiment the vapour mix may be controlled through replacement of air with inert gasses, such as nitrogen, and the pressure within the vessel may be either positive or negative.

In a further embodiment the present invention also relates to an apparatus for use in the removal of solvent from timber, said apparatus comprising:
a chamber capable of withstanding a reduced internal pressure and having means therein for the passage of timber to be treated through at least one opening in the chamber; and
one or more radio frequency energy sources.

In preferred embodiments the chamber may be constructed from a material that limits the emission of radio frequency energy from the apparatus.

In preferred embodiments the apparatus may also include means for measuring solvent concentration within the chamber.

Preferred embodiments of the apparatus according to the invention may comprise means for the monitoring of solvent concentrations within the chamber and means for switching the radio frequency energy source ‘on’ or ‘off’ depending on said concentration.

In preferred embodiments the apparatus may include means for the reduction of pressure within the chamber.

In particularly preferred embodiments the means for reducing the pressure may reduce the pressure in an abrupt fashion, such that the pressure differential created between interior portions and exterior portions of the timber to be treated may assist with the migration of solvent to the surface of the timber.

The means for reducing the pressure in an abrupt fashion may include vacuum ‘accumulators’.

In a further aspect the present invention relates to timber treated by the process according to any aspect of the invention, or treated using the apparatus according to the present invention.

Preferably the process of the present invention may include the additional step of collecting the solvent. The apparatus according to the present invention may therefore advantageously include means for the collection of solvent from within the chamber.

In particularly preferred embodiments the apparatus may include one or more condensers.

In preferred embodiments of the process according to the present invention the timber may be exposed to a temperature of above 40° C.

In particularly preferred embodiments the timber may be exposed to a temperature of around 50° C. to 65° C.

In preferred embodiments of the present invention drying gas is passed over the surface of the timber to be treated at a velocity of greater than 1 m per second.

In particularly preferred embodiments the drying gas may be passed over the surface of the timber to be treated at between about 1.5 m and 2 m per second.

In preferred embodiments the pressure within the vacuum chamber may be varied continuously between vacuum levels to a minimum of −86 kPa and atmospheric pressure.

Without wishing to be bound by any theory the applicant believes that the particular advantages of the method of the invention over inferior and art known methods result from the particular application of exposing the timber to a reduced pressure and a source of radio frequency energy. The particular advantages may result from heat energy being applied at or near the centre of the wood to be treated in combination with the application of reduced pressure in an abrupt fashion allow the solvent trapped within the timber to escape quicker and with the application of less energy than simply applying radio frequency energy or a reduced pressure alone.

The preferred embodiments of the present invention may have a number of advantages over the prior art which may include:
lower cost of production;
speed of operation;
lower environmental impact; and
more environmentally friendly product.

### BRIEF DESCRIPTION OF DRAWINGS

Further aspects of the present invention will become apparent from the following description which is given by way of example only and with reference to the accompanying drawings in which:

FIG. 1 shows an apparatus according to a preferred embodiment of the present invention;

FIG. 2 shows a further preferred embodiment of the apparatus according to the invention; and

FIG. 3 shows a further embodiment of the apparatus according to the present invention.

### BEST MODES FOR CARRYING OUT THE INVENTION

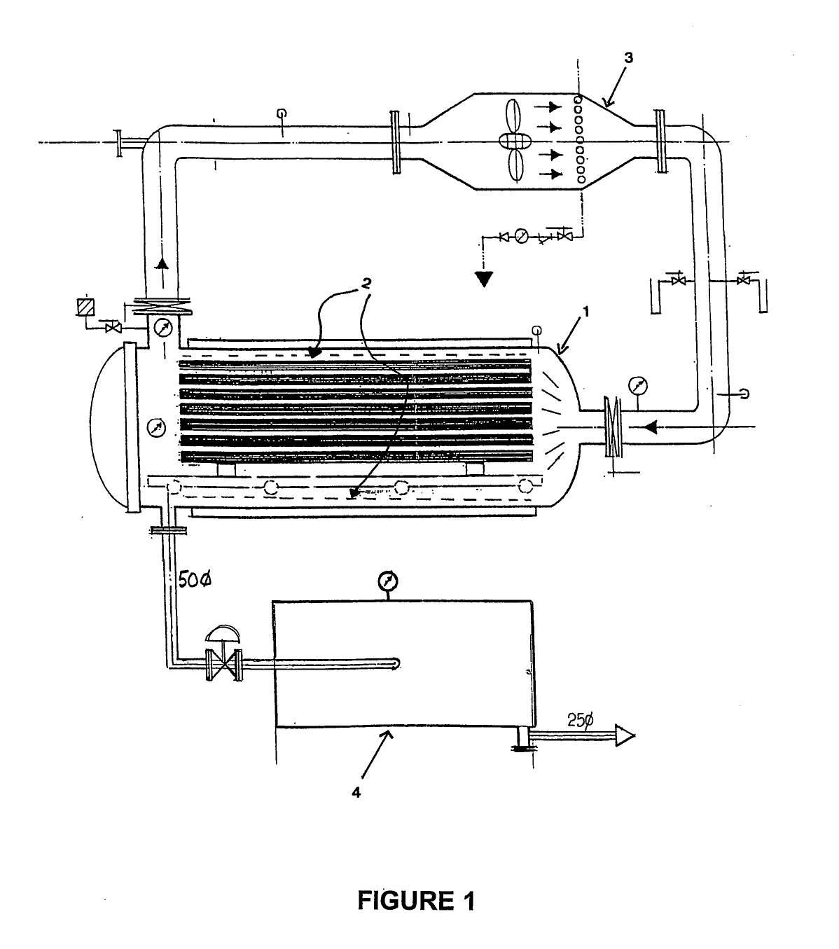

The apparatus according to the invention and as shown in FIG. 1 comprises a vacuum chamber (1) with integral radio wave supplying means (2) in the form of purpose designed electrodes situated above and below the timber load. An air/vapour heating chamber (3) is incorporated and may be controlled so as to be in fluid connection with timber within the drying chamber. A vacuum accumulator (4) may also be in communication with the drying chamber (1). In preferred embodiments of the process according to the invention the vacuum accumulator may be made to be in and out of communication with the drying chamber in response to signals received from within the chamber in response to solvent concentration.

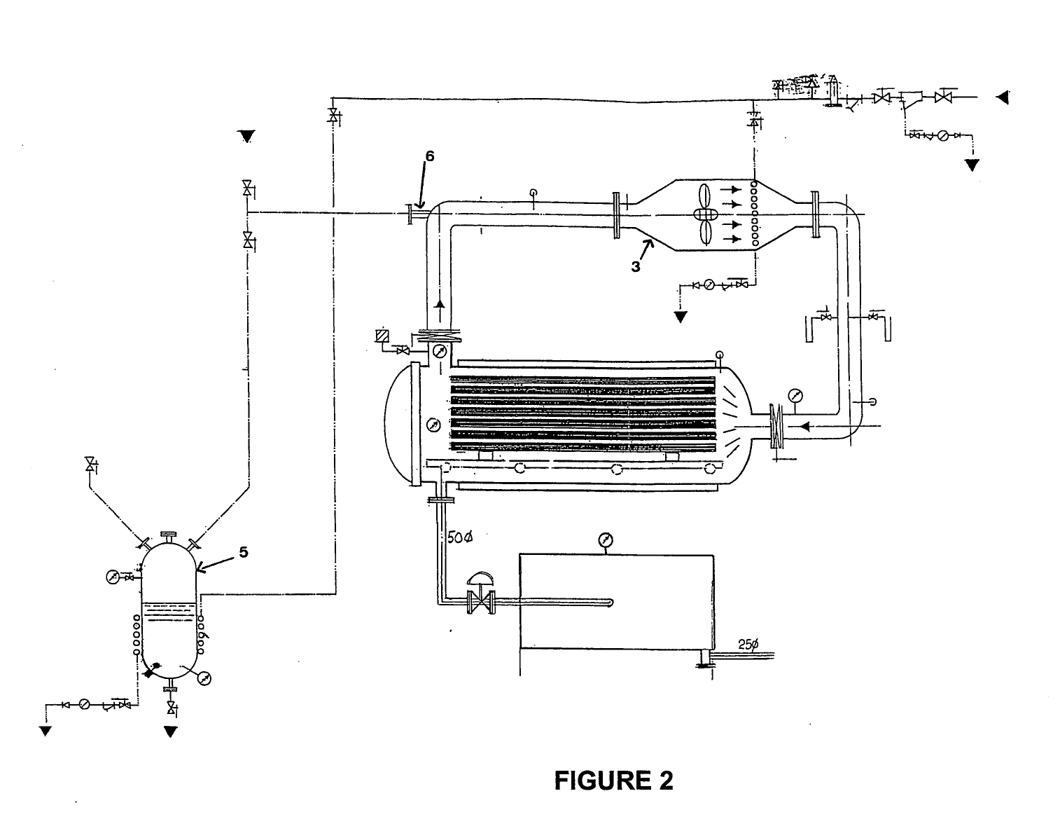

FIG. 2 shows a particularly preferred embodiment of the apparatus according to the present invention comprising a heated source of drying gas (5) with an injection line (6) into the air/vapour heating chamber (3). In particularly preferred embodiments the heating gas is a hot mixture of solvent and air.

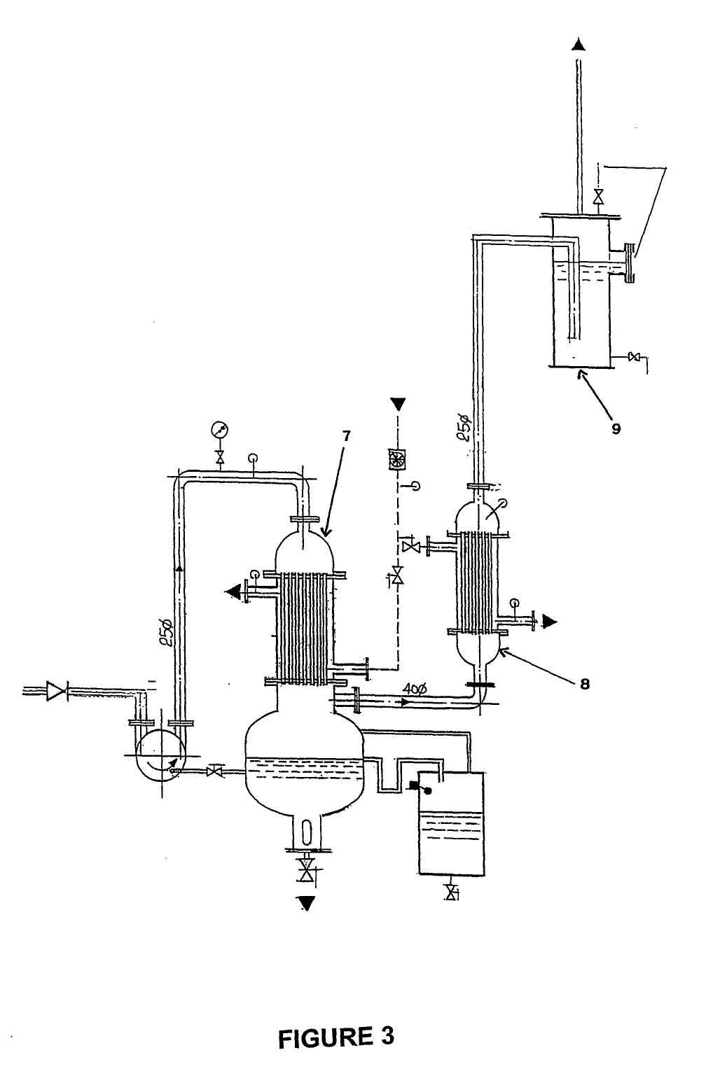

FIG. 3 shows a particularly preferred embodiment of the apparatus according to the present invention which comprises a pair of condensers (7, 8) and an exhaust scrubber (9). In use the condensers cause much of the solvent vapour to precipitate. This precipitation is collected and reused. Any solvent not recovered by the condensers may be scavenged by the exhaust scrubber (9).

In use the vacuum accumulator causes pressure change within the drying chamber to occur rapidly such that large pressure gradients are set up within the timber during drying. This large pressure gradient encourages solvent trapped deep within the wood to travel to the surface and facilitates the improved percentage recovery of solvent from the timber.

### EXAMPLE 1

Forty pieces of selected timber, 45 mm×90 mm×500 mm long, with a moisture content of between 10% to 18%, were separately treated in an LOSP plant to an uptake figure equating to 40 L/m³. After treatment the timber was rapidly transferred to the solvent recovery vacuum vessel according to a preferred embodiment of the present invention and the door locked and sealed.

A deep vacuum was then introduced to remove the bulk of the air. Nitrogen or solvent vapours may optionally be introduced into the vessel to achieve conditions where the solvent concentration is lower than the lower explosive limit or higher than the upper explosive limit of the LOSP solvents.

The timber is then subjected to radio frequency energy of substantially 40 MHz in order to heat the residual water within timber cells to around 50° C. The temperature may be controlled by measuring the current being drawn by the frequency generator. The radio frequency is applied in a “balanced mode” specifically designed to ensure even heating throughout the timber. Radio frequency energy was applied for between 10 to 30 minutes to achieve a target temperature of 50° C.

When the target temperature is reached, the process enters the solvent recovery phase. The heated timber is subjected to a series of a rapid pressure changes, progressively lowering the pressure within the vessel to around −86 kPa in order to assist the movement of absorbed solvents toward the surface of the wood.

Some embodiments of the method of the invention involve heating the gas/vapour mixture using heat exchanging coils and passing this heated gas/vapour at predetermined velocities over the surface of the timber. The heated gas/vapour helps remove solvents being released from the surface of the timber. A portion of the gas/vapours may be passed through condensers in order to extract and retain evaporated solvent.

Aspects of the present invention have been described by way of example only and it should be appreciated that modifications and additions may be made thereto without departing from the scope thereof.

1-32. (canceled)

33. A use of a reduced pressure and a source of radio frequency energy sufficient to heat timber to a temperature of substantially 40° C. to remove solvent from the timber.

34. A process for removal of solvent from treated timber comprising the step of exposing the treated timber to a reduced pressure and a source of radio frequency energy sufficient to heat timber to a temperature of substantially 40° C.

35. The process as claimed in claim 34, wherein the treated timber is timber which has been treated with any number of agents selected from the group: insecticides; fungicides; bactericides; flame retardants; and any preservative or other treatment chemical.

36. The process as claimed in claim 35, where the preservative or other treatment chemical includes at least one member of the group comprising: dinitrophenol; pentachlorophenol; chloronaphthalenes; chlorobenzenes; lindane; dieldrin; organophosphorous and carbamate compounds; and copper/zinc naphthenates.

37. The process as claimed in claim 35, wherein the treated timber is timber treated with a preservative.

38. The process as claimed in claim 35, wherein the solvent is any substance or combination of substances that is normally a liquid at room temperature and pressure or any substance capable of dissolving any timber treatment agent.

39. The process as claimed in claim 38, wherein the solvent is an organic solvent.

40. The process as claimed in claim 38, wherein the solvent is light organic solvent or a petroleum fraction between gasoline and kerosene.

41. The process as claimed in claim 34, wherein the timber is processed timber.

42. The process as claimed in claim 34, wherein the timber has been treated with an approximately 10% w/v solution of a timber preservative in light organic solvent.

43. The process as claimed in claim 34, wherein the radio frequency energy is applied intermittently.

44. The process as claimed in claim 43, wherein the radio frequency energy is substantially 40 MHz.

45. The process as claimed in claim 34, wherein the radio frequency energy is applied into a vapour mix at the surface of the timber is either above the upper explosive level or below the lower explosive level of the solvent.

46. The process as claimed in claim 34, wherein the pressure is reduced rapidly such that the pressure differential between the interior of the timber and the surface of the timber assists in the migration of solvent to said timber surface.

47. The process as claimed in claim 34, wherein a vapour mix is controlled through replacement of air with inert gasses, such as nitrogen, and the pressure within the vessel is either positive or negative.

48. Use of an apparatus for the removal of solvent from timber, said apparatus comprising:
a chamber capable of withstanding a reduced internal pressure and having means therein for the passage of timber to be treated through at least one opening in the chamber;
one or more radio frequency energy sources, and
a means for measuring solvent concentration within the chamber.

49. An apparatus as claimed in claim 48, wherein the chamber is constructed from a material that limits the emission of radio frequency energy from the apparatus.

50. An apparatus as claimed in claim 48, wherein the apparatus also includes means for switching the radio frequency energy source ‘on’ or ‘off’ depending on the solvent concentration within the chamber.

51. An apparatus as claimed in claim 48, which includes a means for the reduction of pressure within the chamber.

52. The apparatus as claimed in claim 51, wherein the means for reducing the pressure reduces the pressure in an abrupt fashion, such that the pressure differential created between interior portions and exterior portions of the timber to be treated assists with the migration of solvent to the surface of the timber.

53. The apparatus as claimed in claim 52, wherein the means for reducing the pressure in an abrupt fashion includes vacuum ‘accumulators’.

54. An apparatus as claimed in claim 48, which includes the additional step of collecting the solvent from within the chamber.

55. An apparatus as claimed in claim 48, which includes one or more condensers.

56. The process as claimed in claim 44, wherein drying gas is passed over the surface of the timber to be treated at a velocity of greater than substantially 1 m per second.

57. The process as claimed in claim 56, wherein the drying gas is passed over the surface of the timber at between substantially 1.5 m and 2 m per second.

58. The process as claimed in claim 44, wherein the pressure within the vacuum chamber is varied continuously between vacuum levels to a minimum of substantially −86 kPa and atmospheric pressure.
